(19) United States
(12) Patent Application Publication
(10) Pub. No.: US 2006/0227355 A1
(43) Pub. Date: Oct. 12, 2006

(54) System and method for applying unique output characteristics to documents in a document set

(75) Inventors: Rohit Wadhwa, Tustin, CA (US); Manmohan Garg, Cerritos, CA (US); Hongfeng Wei, Anaheim, CA (US)

Correspondence Address: TUCKER, ELLIS & WEST LLP, 1150 HUNTINGTON BUILDING, 925 EUCLID AVENUE, CLEVELAND, OH, 44115-1414, US

(73) Assignees: Toshiba Corporation; Toshiba Tec Kabushiki Kaisha

(21) Appl. No.: 11/100,708

(22) Filed: Apr. 7, 2005

(51) Int. Cl. G06F 3/12

(52) U.S. Cl. 358/1.13

(57) ABSTRACT

The present invention is directed to a system and method for applying a unique output characteristic to each document in a document set. The system and method is for use with a document processing system wherein multiple copies of a document are generated and each copy of the document has a unique output characteristic which distinguishes that copy from the other copies of the document set. In one embodiment, each copy has at least one of a unique watermark inserted or applied to the copy or is generated on a unique output medium so as to distinguish such copy from the other copies in the document set.

### BACKGROUND OF THE INVENTION

This invention is directed to a system and method for applying unique output characteristics to each document in a document set. More particularly, this invention is directed to a system and method for use with a document processing system to apply a unique output characteristics to each document in a document set. For example, this invention allows a different watermark to be applied or a different paper type to be used for each document when multiple copies of a document are generated.

Users of document processing systems often desire to generate multiple copies of a document. Typically each copy of the document is for a different purpose, such as file copy, a client copy, invoice, work order, and the like. In order to distinguish each copy, a different output characteristic, such as a watermark or paper type, is applied or used with each copy. Current document processing devices have the ability to generate multiple copies by generating the document once, but do not have the ability to apply a unique attribute to each copy. In addition, current document processing devices also have the ability to choose a different paper type for different pages of a document, but are not able to easily generate multiple copies of a document wherein each document has a different paper type.

If a user desires to generate multiple copies of a document wherein each copy has a different output characteristic using current document processing systems, the user must perform one of several tedious processes. One such method requires that document is generated multiple times and the paper type is changed for each copy. Another method requires that the document is generated such that multiple copies of the same page are generated and different paper type is selected for different copies of a page and one copy of such document is generated. A third method requires that multiple copies of the document are generated using a bypass feeder for the paper source and the user manually keeps track of the copies and changes the paper for each copy. Another method requires the use of multi-part forms, such as “carbon copy” forms. This requires the use of an impact printer, such as a dot matrix printer. Impact printers are relatively rare, noisy, expensive to operate and typically of lower quality than laser, ink jet, thermal printers, and the like. If the user frequently has to generate documents wherein each copy must be distinguished from other copies, these processes are time consuming, lower quality, expensive and prone to errors.

This invention overcomes the aforementioned problems and provides a system and method for applying unique output characteristics to each copy of a document in a document set.

### SUMMARY OF THE INVENTION

In accordance with the present invention, there is provided a system and method for applying unique output characteristics to each document in a document set.

Further, in accordance with the present invention, there is provided a system and method for use with a document processing system which applies a unique output characteristic to each document in a document set.

Further, in accordance with the present invention, there is provided a system and method for generating multiple copies of a document wherein each copy is distinguishable from the other copies.

Further, in accordance with the present invention, there is provided a system and method for generating multiple copies of a document wherein each copy has at least one of a unique watermark inserted or applied to the copy or is generated on a unique output medium so as to distinguish such copy from the other copies in the document set.

Still further, in accordance with the present invention, there is provided a system for applying unique output characteristics to documents of a document set. The system comprises input means adapted for receiving document data representative of an selected document from which multiple distinctive outputs are desired and means adapted for receiving instruction data representative of a plurality of distinctive output properties, each output property to be associated with at least one of the multiple distinctive outputs. The system further comprises association means adapted for associating each distinctive output property to the at least one of the multiple distinctive outputs and output means adapted for communicating the document data to an associated document processing device to form a plurality of distinctive documents as specified by the instruction data.

Still further, in accordance with the present invention, there is provided a method for applying unique output characteristics to documents of a document set. The method comprising the steps of receiving document data representative of an selected document from which multiple distinctive outputs are desired and receiving instruction data representative of a plurality of distinctive output properties, each output property to be associated with at least one of the multiple distinctive outputs. The method further comprises the steps of associating each distinctive output property to the at least one of the multiple distinctive outputs and communicating the document data to an associated document processing device to form a plurality of distinctive documents as specified by the instruction data.

In a preferred embodiment of the invention, the document data is received as digital document data associated with at least one document processing request. Preferably, the document processing request includes a print request, a copy request, and a scan request. Preferably, the document processing device is a printing device, a copying device, a scanning device, and a multifunctional peripheral device.

In one embodiment of the present invention, the instruction data includes watermark data representative of a plurality of unique watermarks, each unique watermark being associated with at least one of each of the plurality of distinctive documents.

In another embodiment of the present invention, the instruction data includes sheet data representative of a plurality of unique output medium characteristics, each unique output medium characteristic being associated with at least one of each of the plurality of distinctive documents. Preferably, each unique output medium characteristic is associated with a selected paper stock.

Still other advantages, aspects and features of the present invention will become readily apparent to those skilled in the art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

The subject invention is described with reference to certain parts, and arrangements to parts, which are evidenced in conjunction with the associated drawings, which form a part hereof and not, for the purposes of limiting the same in which:

FIG. 1 is a block diagram illustrative of the system of the present invention;

FIG. 2 is a flowchart illustrative of the method of the present invention;

FIG. 3 is a flowchart illustrative of one embodiment of the present invention wherein a unique digital watermark is inserted into each visual rendering of a document of a document set according to the present invention;

FIG. 4 is a flowchart illustrative of the method of populating the watermark repository according to the present invention; and

FIG. 5 is a flowchart illustrative of one embodiment of the present invention wherein a unique paper type is used for each visual rendering of a document of a document set according to the present invention.

### DETAILED DESCRIPTION OF THE PREFERRED EMBODIMENT

The present invention is directed to a system and method for applying a unique output characteristic to each document in a document set. The system and method is for use with a document processing system wherein multiple copies of a document are generated and each copy of the document has a unique output characteristic which distinguishes that copy from the other copies of the document set. In one embodiment, each copy has at least one of a unique watermark inserted or applied to the copy or is generated on a unique output medium so as to distinguish such copy from the other copies in the document set. As will be understood by those skilled in the art, a watermark is a glyph, icon, figure, text, or other graphical image inserted into the background of a page during output of a document. The use of watermarks is well known in the art and the various types of watermarks are incorporated herein.

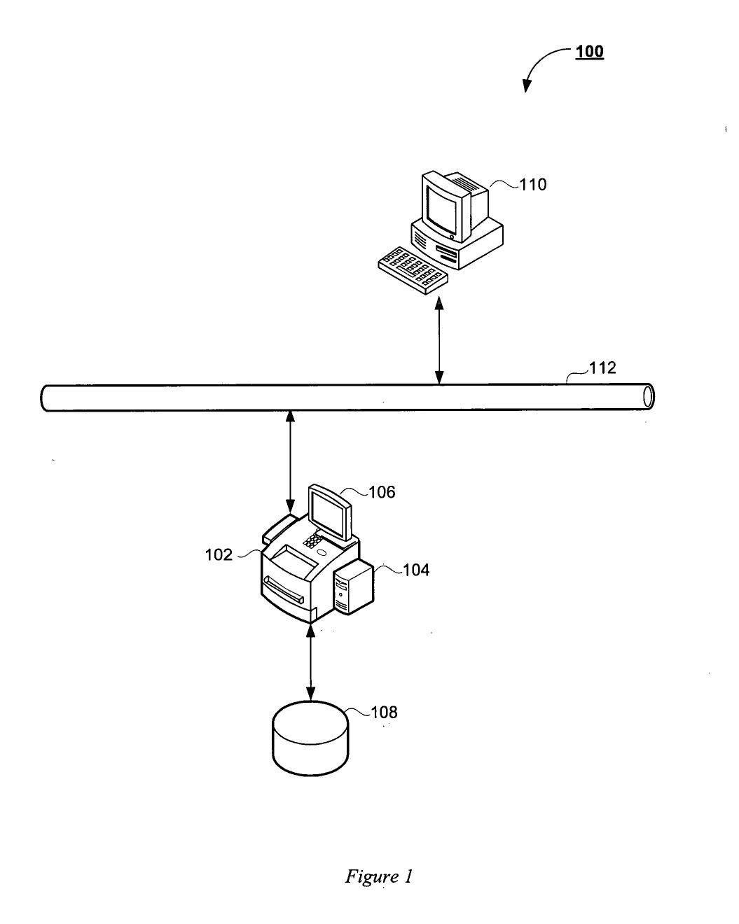

FIG. 1 illustrates a block diagram preferred embodiment of the system according to the present invention generally designated as 100. The system comprises at least one document processing device, as illustrated by multifunction peripheral device 102, for generating or processing image data. It is to be appreciated that the document processing device 102 is any suitable document processing device known in the art, such as a printer, copying device, scanning device, facsimile, multifunctional peripheral device, and the like, or any combination thereof. Suitable commercially available document processing devices include, but are not limited to, the Toshiba e-Studio Series Controller.

The document processing device 102 of the system 100 further comprises a controller 104, which controls the functions of the document processing device 102 as will be appreciated by one of ordinary skill in the art. The controller 104 is capable of being externally or internally coupled to the multifunctional peripheral device 102. The controller 104 is advantageously any hardware, software, or combination thereof suitably capable of controlling the functioning of the document processing device 102 as will be appreciated by one of ordinary skill in the art.

The document processing device 102 suitably includes a user interface 106, in operative connection thereto. The user interface 106 is preferably a touch screen display, capable of both displaying data to a user, as well as receiving user input. The skilled artisan will appreciate that any suitable user interface known in the art, including, without limitation, an alphanumeric keypad, an LCD, and the like, are equally capable of being employed by the present invention. The document processing device 102 suitably includes an associated memory, illustrated in FIG. 1 as data storage device 108, suitably adapted to store electronic files, including, without limitation, electronic documents, images, and the like. The skilled artisan will appreciate that the data storage device 108 is any mass storage device known in the art, including, but not limited to flash memory, magnetic data storage, optical data storage and the like. As will be understood with respect to the present invention, the data storage device 108 functions as a watermark repository, storing various images and associated identifiers, for incorporation during document processing operations, as will be explained in greater detail below. The system also facilitates creation of multiple copies, and the like, with the use of non-impact printers, such as laser printers, ink jet printers, thermal printers, and the like. The system allows for creation of such multiple copies or uniquely marked copies without the necessity of insertion of specialized paper, and such generation is advantageously facilitated through a user interface associated with an image generating device driver, such as a print driver, in a document processing application.

A user accesses the document processing device 102 via the user interface 106, to provide instructions and input in accordance with the present invention. In addition, the user is capable of accessing the document processing device 102 via a remote user interface, such as the user device 110, accessing the document processing device 102 via a computer network 112.

The skilled artisan will appreciate that the user device 110 communicates with the document processing device 102 via any data communications channel (not shown) known in the art, including, but not limited to LAN, the Internet, directly via 802.11g (WiFi), Bluetooth, or other 802.11x wireless communications channels. The user device 110 suitably includes an associated storage device (not shown), such as a hard disk drive, for storing one or more electronic files. The user device 110 is shown in FIG. 1 as a desktop computer, however the skilled artisan will appreciate that as explained below this is for exemplification purposes only and the present invention is capable of using a document server, a laptop computer, a tablet computer, and the like, for storing an electronic document file and communicating the same to the document processing device 102.

The user is able to selectively request the application of a unique output characteristic to each copy of a document via the user interface 106, which in the preferred embodiment is associated with an image generating device driver through which a document output operation is to be completed. In the event, the user selects a unique watermark is to be applied to each copy, the user interface 106 is advantageously capable of retrieving images of watermarks from the repository 108 connected to the document processing device 102 and displaying the same to the user. By way of example, a watermark is suitably image based or text based. A representative text based watermark is suitably an indicia such as “Customer Copy,” “Store Copy,” “File Copy,” and the like. In addition, as will be explained below, the user is able to add new watermarks to the watermark repository 108 via the user interface 106 or the user device 110. For example, the user forwards, from the user device 110, to the document processing device 102 an image to be used as a watermark. The watermark, in digital format, is then stored in the repository 108 for later use. In addition, the user, at the user interface 104, is able to add a watermark by scanning a visual rendering, e.g., a hardcopy image, at the document processing device 102. The scanned image is then stored in the repository for later use.

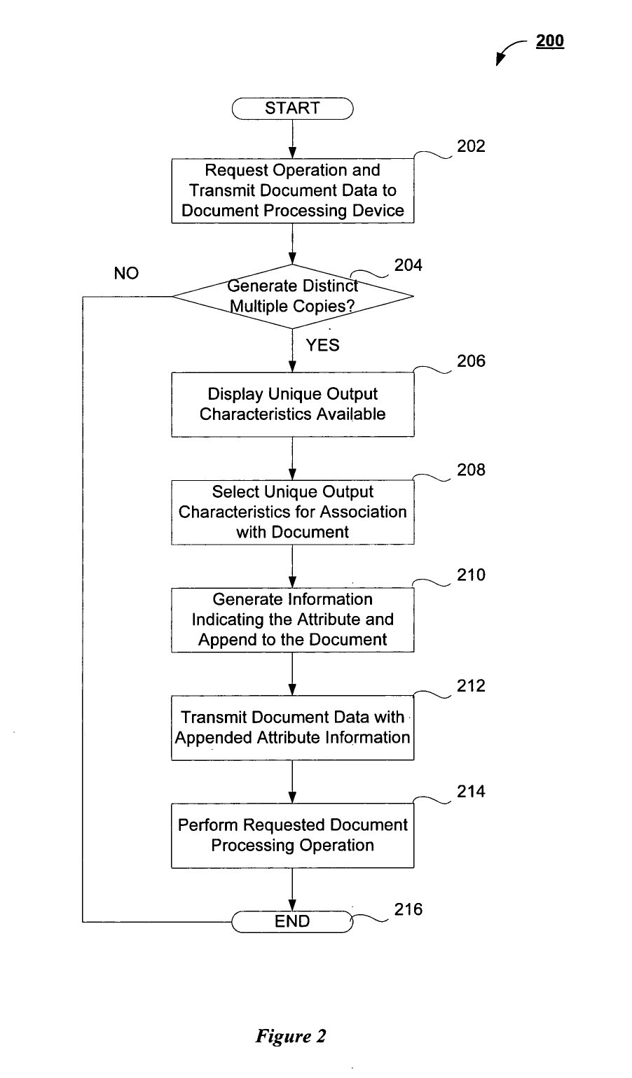

FIG. 2 is a flowchart 200 illustrating the process for applying a unique output characteristic to each document in a document set according to the present invention. At 202, a user requests a document processing operation to be performed on a document and document data is transmitted to the document processing device for processing as discussed above. Flow proceeds to 204 wherein a determination is made whether multiple copies of the document with each document having a unique output characteristic are to be generated for such document processing request. If such distinct multiple copies are not to be generated flow proceeds to 216 and the process ends.

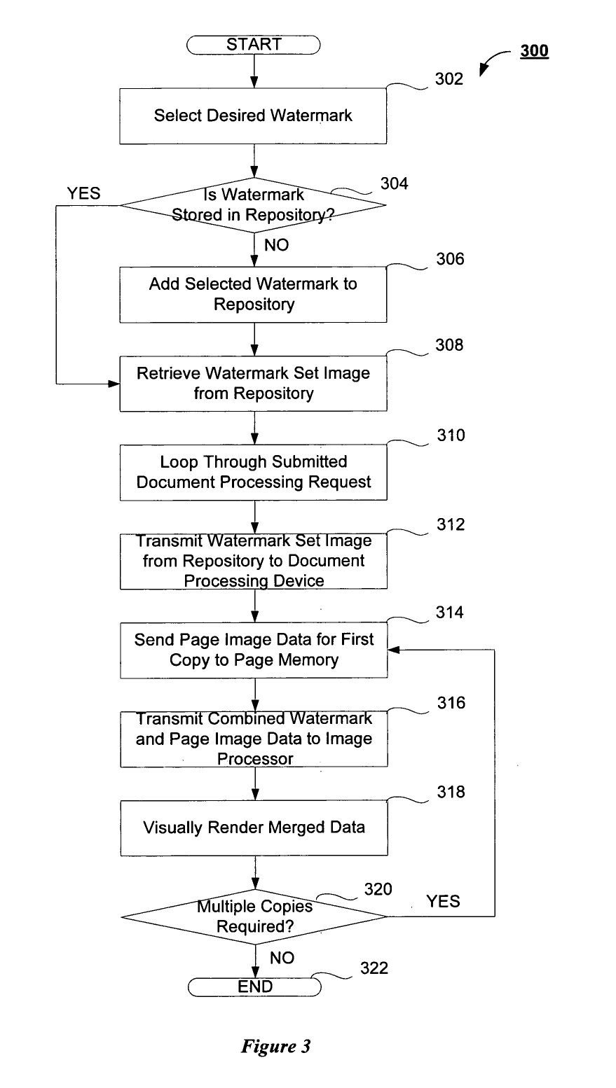

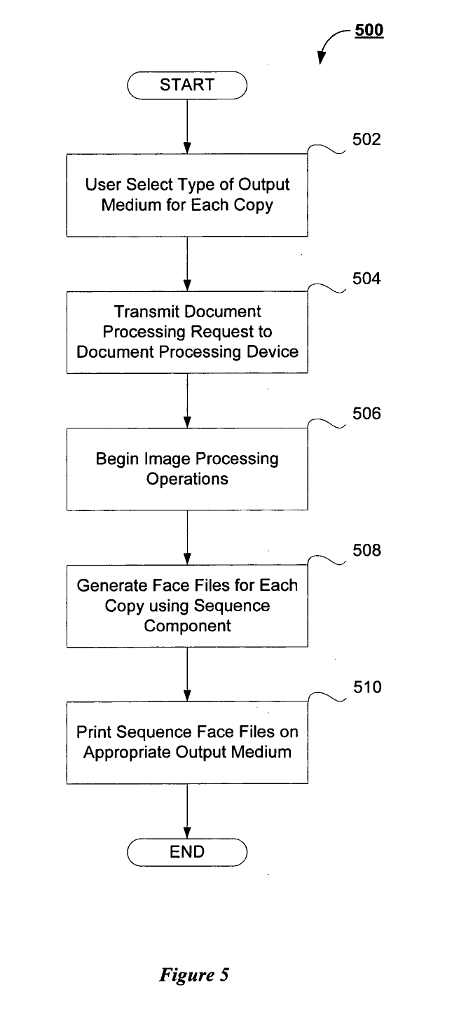

If distinct multiple copies are to be generated, then flow proceeds to 206 wherein the unique output characteristic available to be associated with each document are displayed to the user by suitable means. In a preferred embodiment, the available unique output characteristics include inserting a unique digital watermark into each visual rendering of the document and generating each visual rendering onto a unique paper type. At 208, the user selects at least one unique output characteristic to be associated with each document of the document set by any means known in the art. If the user desires that a unique digital watermark is to be inserted into each visual rendering of the generated document, the process for such insertion is shown in FIG. 3 discussed in detail below. If the user desires that each copy of the document be generated on a unique paper medium, the process for such generation is shown in FIG. 5 discussed in detail below. As noted above, in the preferred embodiment, generation of the multiple, uniquely defined outputs is selected by a user during a document processing operation.

After the user selects at least one unique output characteristic for each copy, flow proceeds to 210 wherein information is generated indicating that a unique attribute is to be associated with each copy of the document and the information is appended to the document data via any suitable means. At 212, the document data is transmitted to the document processing device as will be appreciated by one of ordinary skill in the art. At 214, the requested document processing operation is performed.

In a preferred embodiment, the user selects that a unique digital watermark be inserted into each visual rendering of the document. FIG. 3 is flowchart illustrating inserting a unique watermark into each visual rendering. At 302, the user is prompted to select the appropriate watermark set for inclusion. At 304, a determination is made whether the selected watermark set is stored within the watermark repository 108, or suitably specified by a user. It is to be appreciated that a hybridized watermark is also contemplated, such as when outputs are marked with indicia representative of a numbered copy, such as “Copy 1 of 4,” or a temporally marked copy, such as “Printout of Nov. 29, 2004,” or “Copy Printed at 12:34:56 p.m.”. If the selected watermark set is stored in the repository, then flow proceeds to step 308.

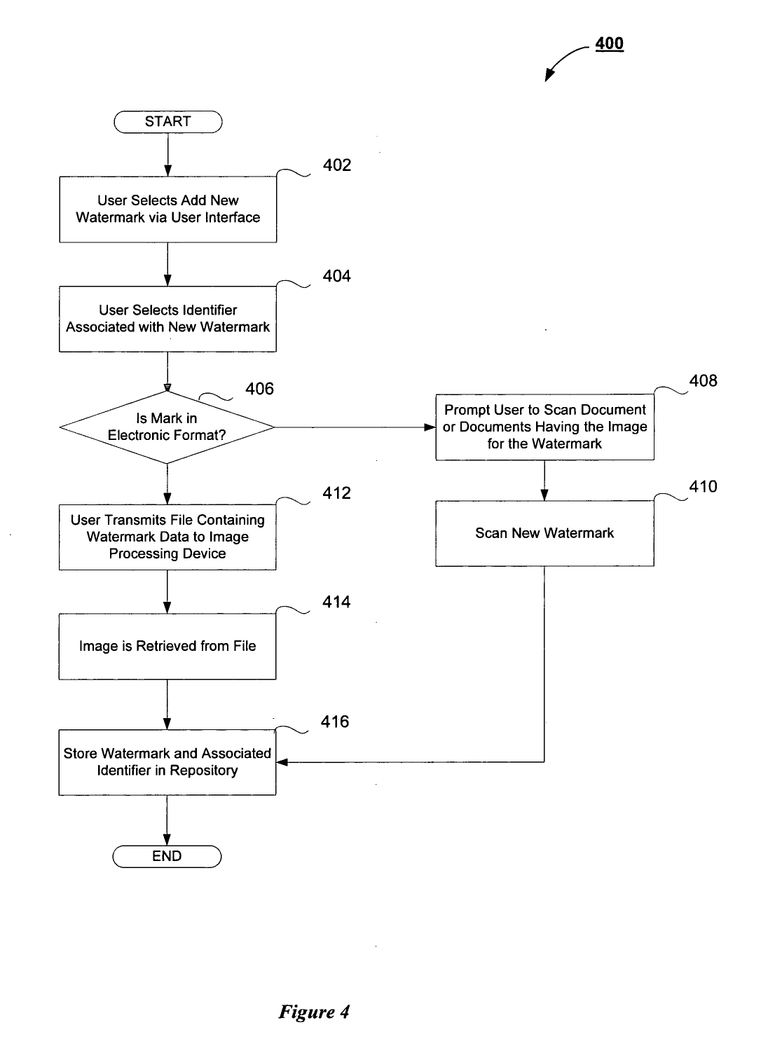

If the selected watermark set is not stored in the watermark repository 108, flow proceeds to step 306 wherein the watermark set is added to the watermark repository 108. The population of the repository is best understood with reference to the flowchart 400 of FIG. 4. Referring to FIG. 4, a user selects to add a new watermark set to the repository 108 at step 402. The skilled artisan will understand that such a selection is suitably made via the user interface 106 or via the user device 108. At step 404, the user provides an identifier to be associated with the new watermark set. For example and without limitation, the user enters an alphanumeric designation for the watermark set, such as a name, which is then associated with the watermark image set in the repository 108. A determination is made at step 406 whether the new watermark set is available in electronic file format. When the user has an electronic copy of the watermark set, the user transmits the watermark set to the document processing device 102 at step 412. As will understood by those skilled in the art, suitable transmission means include, but are not limited to, electronic message transmission, recovery of the electronic file from a removable storage medium, retrieval from a URL, and the like.

At step 414, the images to be used as the new watermark set are retrieved from the electronic file or files. The skilled artisan will appreciate that such retrieval advantageously includes using a printer driver to generate the watermark set in acceptable format for inclusion in documents by the document processing device 102. In addition, it will be appreciated by those skilled in the art that the retrieval is also capable of occurring through the use of ripping a specific image from a page or pages containing other image data. As will be understood by those skilled in the art, acceptable image formats include, without limitation, JPEG, GIF, TIFF, and other image file formats known in the art. The ripped images are then converted to an acceptable format for inclusion in documents by the document processing device 102. In either event, the watermark set and associated identifier are stored in the repository 108 at step 416 for later use in document processing operations. Preferably, the watermark images are stored with one watermark image of each set on a separate page, document, file, or the like and each image is associated with the set.

When it is determined at step 406 that the user does not have an electronic file or files containing the desired images for use as a watermark set, the user is prompted, at step 408, to scan the document or documents having the images desired to be used as a watermark set. The document or documents having the images are then scanned at step 410 and the new watermark set is stored in appropriate format with its associated identifier in the repository 108 at step 416.

At step 308, the designated watermark set image data is retrieved from the repository 110. At step 310, the document processing device 102 begins to loop through the submitted document processing request, e.g., the associated document submitted in the document processing request for document processing operations. At step 312, the retrieved watermark set image data is sent from the repository 110 to the multifunction document processing device 102. At step 314, the page image data for the first copy is sent to the page memory. Preferably, the page image data is sent with an “OR” command, indicating the combining of the watermark image data and the page image data.

The combined watermark image for the first copy and page image data for the first copy is then transmitted to an image processor of the document processing device 102 at step 316. The merged image data is then visually rendered by the document process device 102 at step 318. At step 320, a determination is made whether the multiple copies are to be generated of document associated with the document processing request. When multiple copies are to be generated, the flow returns to step 314 and the next copy of the document to be visually rendered is processed. It is understood that for the second copy, the second watermark image is combined with the page image data for the second copy, for the third copy, the third watermark image, etc. When no additional copies remain to be processed, flow proceeds to step 322, where the document processing request has been fulfilled and document processing operations then terminate. In the event that more copies are generated than there are associated watermark images in the selected watermark set, the additional copies will not have a watermark inserted into the visual rendering thereof. Further, in the event that the selected watermark set contains more watermark images than the number of copies to be generated, the remaining watermarks will be ignored and will not be used in the visual rendering of the document.

In another embodiment, the user selects that each copy of the document is generated on a unique output medium. FIG. 5 is a flowchart 500 illustrating the process for generating each copy on a different type of output medium. At 502, the user selects the type of output medium, such as the type of paper stock, to be used with each copy by any suitable means. At step 504, the document processing request is transmitted to the document processing device. The document processing request contains information, preferably in the form of a header appended to the document data, that each copy is to be printed on a different output medium. At step 506, the document processing device 102 begins to process the submitted document processing request. Preferably, the document is rasterized and each copy is saved as a face file. At 508, a sequencing component generates face files for each copy wherein the paper type of each copy corresponds to the paper type specified in the document processing request. At 510, the sequenced face files are printed on the appropriate output medium.

It is to be appreciated that the subject invention contemplates yet another alternative to distinguishing outputs of documents in a document set. Included are multi-colored outputs wherein the color is supplied by a color rendering output device. Such color rendering is suitably accomplished by generating a colored background on a document, as a substitute for use of output stock of varying colors. Also, contemplated is multiple outputs for which foreground, such as text color, is varied for various output copies. In such an embodiment, and by way of example, a first output copy would use blue text, a second yellow text, a third red, and the like. Alternatively, a bar or other color area is suitably provided as a border or indicia to distinguish varied copies without the necessity of multiple output stock options.

While in the preferred embodiment the present invention is implemented in software, as those skilled in the art can readily appreciate it may also be implemented in hardware or a combination of software and hardware.

Although the preferred embodiment has been described in detail, it should be understood that various changes, substitutions, and alterations can be made therein without departing from the spirit and scope of the invention as defined by the appended claims. It will be appreciated that various changes in the details, materials and arrangements of parts, which have been herein described and illustrated in order to explain the nature of the invention, may be made by those skilled in the area within the principle and scope of the invention as will be expressed in the appended claims.

What is claimed:

1. A system for applying unique output characteristics to documents of a document set comprising:
input means adapted for receiving document data representative of an selected document from which multiple distinctive outputs are desired;
means adapted for receiving instruction data representative of a plurality of distinctive output properties, each output property to be associated with at least one of the multiple distinctive outputs;
association means adapted for associating each distinctive output property to the at least one of the multiple distinctive outputs; and
output means adapted for communicating the document data to an associated document processing device to form a plurality of distinctive documents as specified by the instruction data.

2. The system for applying unique output characteristics to a document set of claim 1, wherein the document data is received as digital document data associated with at least one document processing request.

3. The system for applying unique output characteristics to a document set of claim 2, wherein the at least one document processing request includes a print request, a copy request, and a scan request.

4. The system for applying unique output characteristics to a document set of claim 1, wherein the document processing device includes a printing device, a copying device, a scanning device, and a multifunctional peripheral device.

5. The system for applying unique output characteristics to a document set of claim 1, wherein the instruction data includes watermark data representative of a plurality of unique watermarks, each unique watermark being associated with at least one of each of the plurality of distinctive documents.

6. The system for applying unique output characteristics to a document set of claim 1, wherein the instruction data includes sheet data representative of a plurality of unique output medium characteristics, each unique output medium characteristic being associated with at least one of each of the plurality of distinctive documents.

7. The system for applying unique output characteristics to a document set of claim 6, wherein each unique print medium characteristic is associated with a selected paper stock.

8. A method for applying unique output characteristics to documents of a document set comprising the steps of:
receiving document data representative of an selected document from which multiple distinctive outputs are desired;
receiving instruction data representative of a plurality of distinctive output properties, each output property to be associated with at least one of the multiple distinctive outputs;
associating each distinctive output property to the at least one of the multiple distinctive outputs; and
communicating the document data to an associated document processing device to form a plurality of distinctive documents as specified by the instruction data.

9. The method for applying unique output characteristics to a document set of claim 8, wherein the document data is received as digital document data associated with at least one document processing request.

10. The method for applying unique output characteristics to a document set of claim 9, wherein the at least one document processing request includes a print request, a copy request, and a scan request.

11. The method for applying unique output characteristics to a document set of claim 8, wherein the document processing device includes a printing device, a copying device, a scanning device, and a multifunctional peripheral device.

12. The method for applying unique output characteristics to a document set of claim 8, wherein the instruction data includes watermark data representative of a plurality of unique watermarks, each unique watermark being associated with at least one of each of the plurality of distinctive documents.

13. The method for applying unique output characteristics to a document set of claim 8, wherein the instruction data includes sheet data representative of a plurality of unique output medium characteristics, each unique output medium characteristic being associated with at least one of each of the plurality of distinctive documents.

14. The method for applying unique output characteristics to a document set of claim 13, wherein each unique print medium characteristic is associated with a selected paper stock.

15. A computer-readable medium with computer-readable instructions stored thereon for applying unique output characteristics to documents of a document set comprising:
instructions for receiving document data representative of an selected document from which multiple distinctive outputs are desired;
instructions for receiving instruction data representative of a plurality of distinctive output properties, each output property to be associated with at least one of the multiple distinctive outputs;
instruction for associating each distinctive output property to the at least one of the multiple distinctive outputs; and
instructions for communicating the document data to an associated document processing device to form a plurality of distinctive documents as specified by the instruction data.

16. The computer-readable medium with computer-readable instructions stored thereon for applying unique output characteristics to a document set of claim 15, wherein the document data is received as digital document data associated with at least one document processing request.

17. The computer-readable medium with computer-readable instructions stored thereon for applying unique output characteristics to a document set of claim 15, wherein the instruction data includes watermark data representative of a plurality of unique watermarks, each unique watermark being associated with at least one of each of the plurality of distinctive documents.

18. The computer-readable medium with computer-readable instructions stored thereon for applying unique output characteristics to a document set of claim 15, wherein the instruction data includes sheet data representative of a plurality of unique output medium characteristics, each unique output medium characteristic being associated with at least one of each of the plurality of distinctive documents.

19. The computer-readable medium with computer-readable instructions stored thereon for applying unique output characteristics to a document set of claim 18, wherein each unique print medium characteristic is associated with a selected paper stock.

20. A computer-implemented method for applying unique output characteristics to documents of a document set comprising the steps of:
receiving document data representative of an selected document from which multiple distinctive outputs are desired;
receiving instruction data representative of a plurality of distinctive output properties, each output property to be associated with at least one of the multiple distinctive outputs;
associating each distinctive output property to the at least one of the multiple distinctive outputs; and
communicating the document data to an associated document processing device to form a plurality of distinctive documents as specified by the instruction data.

21. The computer-implemented method for applying unique output characteristics to a document set of claim 20, wherein the document data is received as digital document data associated with at least one document processing request.

22. The computer-implemented method for applying unique output characteristics to a document set of claim 20, wherein the instruction data includes watermark data representative of a plurality of unique watermarks, each unique watermark being associated with at least one of each of the plurality of distinctive documents.

23. The computer-implemented method for applying unique output characteristics to a document set of claim 20, wherein the instruction data includes sheet data representative of a plurality of unique output medium characteristics, each unique output medium characteristic being associated with at least one of each of the plurality of distinctive documents.

24. The computer-implemented method for applying unique output characteristics to a document set of claim 23, wherein each unique print medium characteristic is associated with a selected paper stock.
